(19) United States
(12) Patent Application Publication
(10) Pub. No.: US 2017/0101046 A1
(43) Pub. Date: Apr. 13, 2017

(54) Modular Illumination Device

(71) Applicant: OZG Powersports, Inc., Santee, CA (US)

(72) Inventor: Gong Beiwen, Zhongshan City (CN)

(73) Assignee: OZG Powersports, Inc., Santee, CA (US)

(21) Appl. No.: 15/389,115

(22) Filed: Dec. 22, 2016

Related U.S. Application Data
(63) Continuation-in-part of application No. 14/728,416, filed on Jun. 2, 2015, now abandoned.

(51) Int. Cl. B60Q 1/00; B60Q 1/02; F21V 23/02; F21V 17/00; F21V 31/00; F21V 17/06

(52) U.S. Cl. CPC B60Q 1/0064; F21V 31/005; F21V 17/06; F21V 23/023; B60Q 1/0088; B60Q 1/0005; F21V 17/002; B60Q 1/02; F21Y 2115/10

(57) ABSTRACT

Disclosed is a light fixture having at least one housing extending between a first end and a second end, wherein the housing is mounted to a surface. One or more light modules has a plurality of light emitting diodes (“LEDs”) in an electrical circuit with one another, wherein the electrical circuit is in communication with a power source. The light modules also have case having a first side having one or more electrical connectors extending outwardly therefrom, wherein the one or more electrical connectors are in communication with the electrical circuit and the power source, wherein the first side is contoured to an interior surface of the housing, and wherein a second side of the case is open. The case also has a lens sealingly engaged to the second. The one or more light modules is removably attached within the housing.

### CROSS-REFERENCE TO RELATED APPLICATION

The present application is a continuation-in-part of, and claims priority to U.S. Nonprovisional patent application Ser. No. 14/728,416 filed on Jun. 2, 2015, entitled “A Simply Detachable Integrated LED Fixture” the entire disclosure of which is incorporated by reference herein.

### BACKGROUND OF THE INVENTION

1. Field of the Invention

The present invention relates to the field of illumination devices for use on motor vehicles, and more specifically, to a illumination device containing modules that allows a user to easily and quickly remove and replace damaged or malfunctioning components therein.

2. Description of Related Art

Illumination devices using light emitting diodes (“LEDs”) provide many advantages over traditional light sources, such as florescent lamps and incandescent bulbs. These advantages include high-energy conversion and optical efficiency, robustness, lower operating costs, small size and others. LED illumination devices generally include a plurality of LEDs of the same color or a number of different colors.

LED illumination devices have been commercially available for many years in a number of different form factors. Linear light fixtures generally include a number of LEDs arranged in a line in an elongated emitter housing. LED illumination devices are popular for use on vehicles, both on and off road. The minimal size requirements coupled with the illumination ability and reduced power consumption of LEDs makes LED illumination devices ideal for 12 or 24 volt, direct current power systems typically found on vehicles.

Typically, illumination devices are installed on the front or top of a vehicle and face the direction desired for illumination. This leads to the devices being installed in a foreword-facing orientation. The vehicles on which the illumination devices are installed typically have the ability to travel at speeds in excess of 100 miles per hour. LED illumination devices are often struck by rocks, sand, or other debris typically encountered while driving a vehicle both on and off road. These impacts often render one or more individual LEDs within the illumination device inoperable.

In the event that individual LED bulbs are damaged or otherwise ceases to function properly, the total illuminating ability of the illumination device is diminished. Currently, the user must replace the entire illumination device to restore it to its full illumination ability. Alternatively, current technology allows the user to repair the illumination device but this requires the user to uninstall the entire illumination device, transport it to repair facility, and reinstall the device once the repairs are completed. This repair process forces the user's vehicle to be without proper illumination ability and is costly.

Based on the foregoing, there is a need in the art for an illumination device that allows a user to restore the illumination device's ability easily and without uninstalling the illumination device. Specifically, an illumination device having modular components that are interchangeable and easily replaceable without removing the entire illumination device is needed. Although an improved LED illumination device is disclosed herein, one skilled in the art would understand how the improved interchangeability design may be implemented in lighting fixtures having other form factors or lighting sources.

### SUMMARY OF THE INVENTION

Disclosed is a light fixture having at least one housing extending between a first end and a second end, wherein the housing is mounted to a surface. One or more light modules has a plurality of light emitting diodes (“LEDs”) in an electrical circuit with one another, wherein the electrical circuit is in communication with a power source. The light modules also have case having a first side having one or more electrical connectors extending outwardly therefrom, wherein the one or more electrical connectors are in communication with the electrical circuit and the power source, wherein the first side is contoured to an interior surface of the housing, and wherein a second side of the case is open. The case also has a lens sealingly engaged to the second. The one or more light modules is removably attached within the housing.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an isometric front view of the modular illumination device, according to an embodiment of the present invention;

FIG. 2 is an isometric exploded view of the modular illumination device, according to an embodiment of the present invention.

FIG. 3 is an isometric exploded view of the modular illumination device comprising two housings, according to an embodiment of the present invention.

### DETAILED DESCRIPTION OF PREFERRED EMBODIMENTS

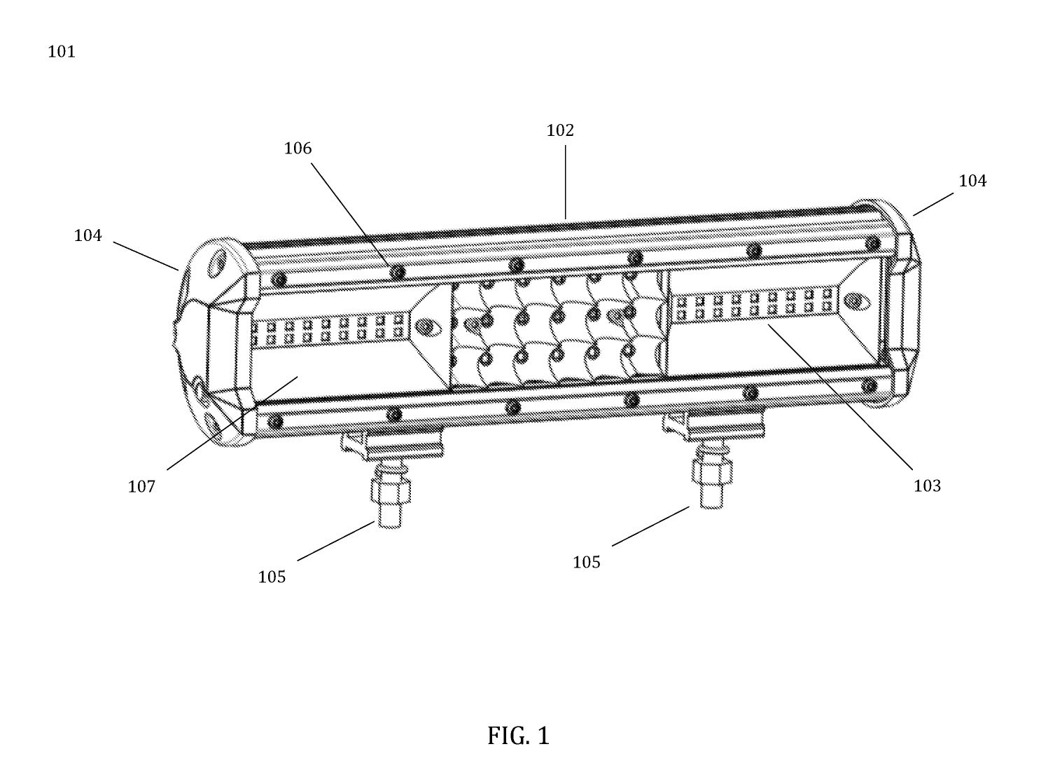

Preferred embodiments of the present invention and their advantages may be understood by referring to FIGS. 1-3 wherein like reference numerals refer to like elements.

In one exemplary embodiment of the present disclosure, the illumination device comprises a housing, a lamp, a programmable control board (“PCB”), one or more housing ends, one or more readily removable housing mounts, and one or more readily removable housing covers.

In another exemplary embodiment of the present disclosure, the housing is made from one or more rigid or semi-rigid materials including metal, polymer, fiber-reinforced polymer, or fibrous materials. In another embodiment of the present disclosure, the housing features a design that maximizes the surface area of the housing to facilitate cooling. In another embodiment of the present disclosure, the housing has cooling fins to allow expeditious convection. In another embodiment of the present disclosure, the housing has contacts on its surface that join with and relay power to one or more housing ends or one or more housing mounts.

In another exemplary embodiment of the present disclosure, the one or more housing ends are made from one or more rigid or semi-rigid materials including metal, polymer, fiber-reinforced polymer, or fibrous materials. The one or more housing ends easily and readily interchange between sides of the house and between other housings comprising the design as presented in this disclosure. In another embodiment of the present disclosure, the one or more housing ends conjoin two housings. In another embodiment of the present disclosure, the one or more housing ends conjoin two housings and relay electrical energy between the two conjoined housings.

In another exemplary embodiment of the present disclosure, the lamp comprises a plurality of bulbs employing one or more illumination technologies including LED, incandescent, halogen, high intensity discharge (“HID”), and compact fluorescent (“CFL”). The lamp is readily removable and replaceable without the use of a tool. In another exemplary embodiment of the present invention, the illumination device comprises one or more lamps. In another embodiment of the present disclosure, the lamp is readily and easily removable and installable into the illumination device without the use of a tool.

In another exemplary embodiment of the present disclosure, the PCB comprises a circuit board and delivers the necessary power from the device's power source to one or more lamps. In another embodiment of the present disclosure, the PCB comprises the ability to control the one or more lamps including the ability to vary the lamp's illumination intensity, allow the lamp to flash on present or user-defined intervals, and vary the color output of one or more or the bulbs.

In another exemplary embodiment of the present disclosure, the housing mounts are easily and readily removable without using a tool. The housing mounts easily and readily detach from the housing or housing end. In another embodiment of the present disclosure, the housing mounts easily and readily attach and detach two housings together. In such an arrangement, a plurality of housings can be stacked on one another. In another embodiment of the present disclosure, the housing mounts are also configured to readily and easily attach and detach from mounting locations that are capable of transmitting electrical energy between multiple housings. In another embodiment of the present disclosure, the housing mounts are configured relay electrical energy from its mounting point to the lamp.

In another exemplary embodiment of the present disclosure, the one or more readily removable housing covers comprise a lens and a gasket. The lens is made from one or more transparent or semi-transparent materials including a polymer, plastic, glass, or acrylic. In one exemplary embodiment of the present disclosure, the lens is flat and does not alter the light emitting from the lamps. In another embodiment of the present disclosure, the lens comprises a concave shape to focus or otherwise alter the light emitting from the lamps. In another embodiment of the present disclosure, the lens comprises a convex shape to disburse or otherwise alter the light emitting from the lamp. In another embodiment of the present disclosure, the lens comprises one or more colors to alter the color of the light emitted from the lamp. In another exemplary embodiment of the present disclosure, the lens comprises a gasket whereby the lens, gasket and housing form an airtight seal to prevent dirt, debris, or moisture from entered the housing through the interface between the housing and the lens. In another exemplary embodiment of the present disclosure, the lens is attached to the house using an easily and readily removable method of securing including a twist-lock, cam-lock, wing nut, or quick release. In another embodiment of the present disclosure, the lens is attached to the housing using on or a combination of one or more latches, one or more straps, one or more ties, and one or more sealants.

In another exemplary embodiment of the present disclosure and with reference to FIG. 1, the modular illumination device 101 comprises a housing 102, a lamp 103, one or more housing ends 104, one or more housing mounts 105, one or more lens locks 106, and a lens 107. The housing 102 comprises an elongated and hollow interior with said hollow interior exposed at two distal ends and along one elongated side. The one or more housing ends 104 are configured to enclose the housing's 102 distal ends. The lens 107 is attached to the housing 102 using one or more lens locks 106. The lens locks 106 are configured to be readily and easily removable while maintaining the modular illumination device's 101 weather resistance. The one or more housing mounts 105 are removeably attached to the housing 102. The housing mounts 105 are configured to relay electrical energy between plurality of modular illumination devices 101.

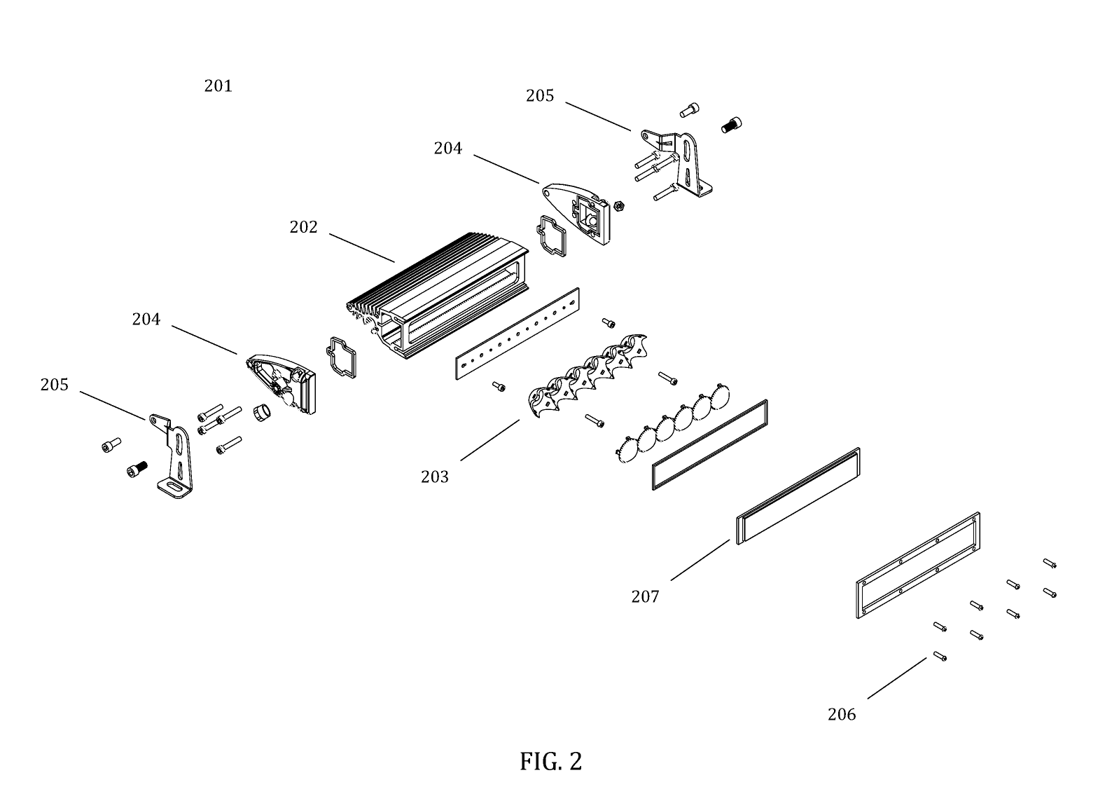

In another exemplary embodiment of the present disclosure and with reference to FIG. 2, the modular illumination device comprises a housing 202, a lamp 203, one or more housing ends 204, one or more housing mounts 205, one or more lens locks 206, and a lens 207. In one embodiment, the housing 202 comprises an exterior surface, an interior, and a hollow and elongated shape with the housing's interior exposed at the distal ends and along one side. In another embodiment of the present disclosure, the housing's 202 exterior surface comprises ribs that increase the modular illumination device's surface area. The one or more housing ends 204 are configured to attach to one or more housings 202 in series. In another embodiment of the present invention, the one or more housing ends 204 are configured to relay power between one or more housings 202 to which the one or more housing ends 204 are attached. In another embodiment of the current disclosure, the one or more housing ends are configured to be readily and easily removably attached to a housing mount 205.

The housing's 202 interior is configured to receive the lamp 205. The lamp 203 is removably attached to the housing's 202 interior. The lens 207 is attached to the housing 202 using one or more lens locks 206. The lens locks 206 are configured to be easily and readily removable. The lens locks 206 secure the lens 207 against the housing 202 such that the interface between the lens 207 and the housing 202 is airtight.

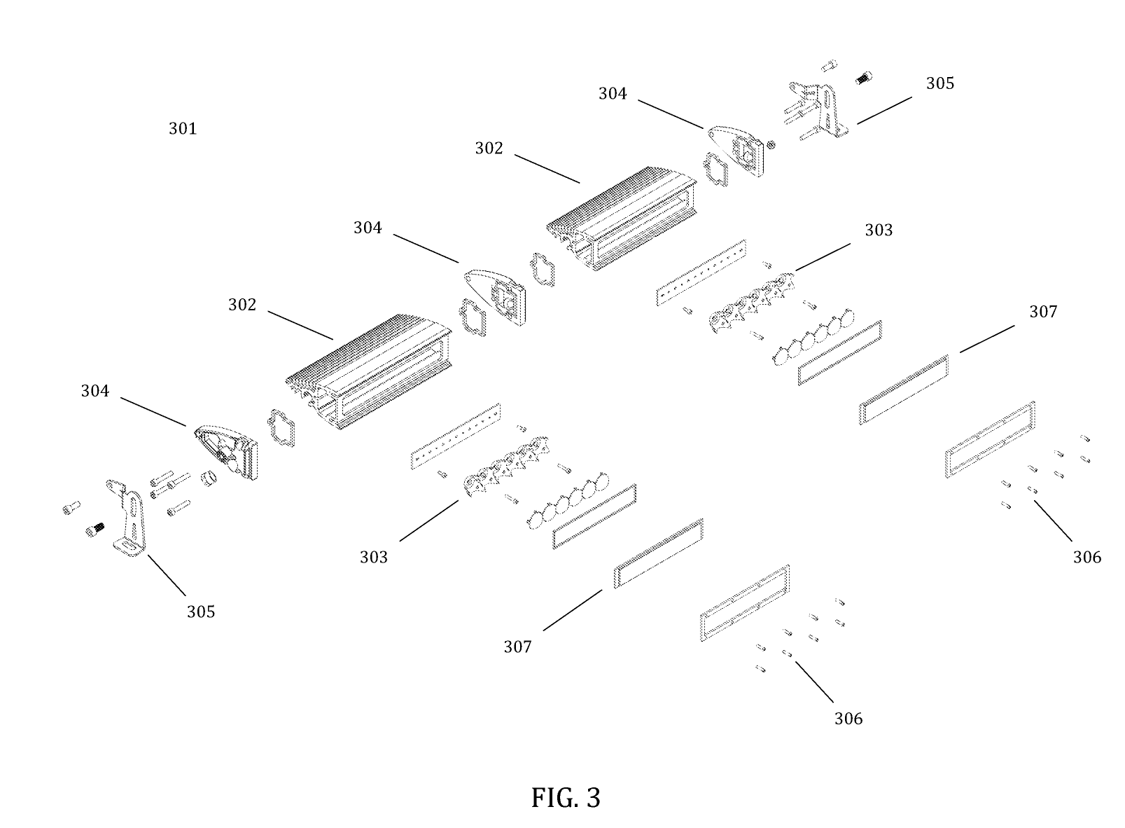

In another exemplary embodiment of the present disclosure and with reference to FIG. 3, the modular illumination device 301 is conjoined in series and comprises one or more housings 302, one or more housing ends 304, one or more housing mounts 305, one or more lamps 303, one or more lenses 307, and a plurality of lens locks 306. In one embodiment, the one or more housings 302 comprises an exterior surface, an interior, and a hollow and elongated shape with the housing's interior exposed at the distal ends and along one side. The one or more housing ends 304 are removable attached to the one or more housings 302 at each distal end. When conjoined in series, the one or more housings 302 are removably attached at their respective distal ends by a housing end 304. In another exemplary embodiment of the present disclosure, the housing end 304 is configured to relay power between the one or more housing ends 302. In another exemplary embodiment, the one or more housing ends 304 is configured to be removably attached to the one or more housings 302 and the one or more housing mounts 305.

In another exemplary embodiment of the present disclosure, the one or more lamps 303 are configured to be easily and readily detachable from the one or more housings' 302 interiors and is configured to be interchangeable between multiple housings 302. The plurality of lens locks 306 removably attaches the one or more lenses 307 to the one or more housings 302. The one or more lens locks 306 are configured to be readily interchangeable with multiple one or more lenses 307 and multiple one or more housings 302. In another embodiment of the present disclosure, the modular illumination device 301 comprises one or more lens locks 306. In another embodiment, the one or more lens locks 306 are configured to be readily and easily detachable.

In another exemplary embodiment of the present disclosure, the illumination device has a singular housing extending between at least two end caps. A conduit disposed within the housing directs electrical connections between one or more light modules and a power source. The one or more light modules are removeably engaged with the housing such that each module is interchangeable based on malfunction, damage, or a user desired effect. Each light module has a casing configured to fit within the housing and a substantially transparent lens or cover on an opposite end of the module inserted into the housing. Within the casing is a plurality of LEDs wired to a PCB. The LEDs are disposed within the case such that light emitted therefrom is directed towards the lens. One or more electrical connections extends through the casing to allow for contact with the conduit within the housing and the power source.

In another exemplary embodiment of the present disclosure, the housing has static dimensions and can accept one or more separate light modules. Each light module may have varying dimensions to allow for a specific configuration of the light output desired by the user.

In another exemplary embodiment of the present disclosure, the housing has dynamic dimensions wherein the length of the housing is extendable to accommodate varying numbers of LED modules. Each LED module is electrically connected to the power source and may be electrically connected to another LED module within the same housing

In another exemplary embodiment, the casing has a removable lens whereby a frame outlines the perimeter of the lens providing for a waterproof and air-tight seal between the lens and the casing.

In another exemplary embodiment of the present disclosure, in use, the housing is installed on a surface such as the body of a vehicle. The length of the housing is determined based on the installation location and number of LED modules to be installed. After the housing has been installed, one or more LED modules are attached to the housing and electrical connections are completed to divert power from a power source through the housing to each LED module. If there is damage to an LED module such as a rock causing the lens to fracture, the user removes the damaged LED module from the housing and replaces it with a new module.

In another embodiment, the housing is installed and subsequently the user determines a need for the installation of more LED modules. The housing is then extended whereby the user pulls each end of the housing in opposite directions, relative to one another until the desired length of housing is reached. The desired length of housing is determined by the number of LED modules to be installed therein. The final length of the housing determines the capacity for the number of LED modules capable of being installed therein. The LED modules are inserted into the housing such that electrical connections, in communication with the LEDs, extending from the housing contact the electrical connections within the housing.

In another embodiment, the user determines that the lens need to be replaced. The damaged lens is detached from the casing either by removing one or more fasteners or prying away from the casing against a friction fit. A new lens is then installed into the casing using the same method of fastening, in reverse.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A light fixture comprising:
a. at least one housing extending between a first end and a second end, wherein the housing is mounted to a surface; and
b. one or more light modules comprising:
i. a plurality of light emitting diodes (“LEDs”) in an electrical circuit with one another, wherein the electrical circuit is in communication with a power source;
ii. a case having a first side having one or more electrical connectors extending outwardly therefrom, wherein the one or more electrical connectors are in communication with the electrical circuit and the power source, wherein the first side is contoured to an interior surface of the housing, and wherein a second side of the case is open; and
iii. a lens sealingly engaged to the second side of the case, wherein the plurality of LEDs are entirely within the case, and wherein the one or more light modules is removably attached within the housing.

2. The light fixture of claim 1, further comprising at least one gasket between the lens and the case, wherein the case is waterproof

3. The light fixture of claim 1, wherein the at least one housing has an extendable length defined by a distance between the first end and the second end.

4. The light fixture of claim 1, further comprising a conduit within the housing extending from the first end to the second end, wherein the conduit directs electrical connections from the power source to the one or more light modules.

5. The light fixture of claim 1, wherein more than one LED module is installed within the housing.

6. The light fixture of claim 1, further comprising one or more filters disposed within the case between the plurality of LEDs and the lens
